(19) United States
(12) Patent Application Publication
(10) Pub. No.: US 2026/0202722 A1
(43) Pub. Date: Jul. 16, 2026

(54) ADAPTER APPARATUS, LENS SYSTEM, AUXILIARY APPARATUS, AND IMAGING SYSTEM

(71) Applicant: CANON KABUSHIKI KAISHA, Tokyo (JP)

(72) Inventors: KEIICHIRO SAITO, Tokyo (JP); KENICHIRO YAMASHITA, Chiba (JP); TOSHIKI MIYAKAWA, Kanagawa (JP); SOUHEI MIYAMOTO, Kanagawa (JP)

(21) Appl. No.: 19/429,340

(22) Filed: Dec. 22, 2025

(30) Foreign Application Priority Data
Jan. 14, 2025 (JP) 2025-004485

(51) Int. Cl. G03B 17/56; G03B 15/03; G03B 17/12

(52) U.S. Cl. CPC G03B 17/566; G03B 15/03; G03B 17/12; G03B 2215/056

(57) ABSTRACT

Adapter apparatuses, lens systems, and imaging systems are provided. One or more adapter apparatuses for attaching an auxiliary apparatus to a lens apparatus may include a first attachment portion attachable to the lens apparatus, and a second attachment portion to which the auxiliary apparatus is attachable. A distance between the first attachment portion and the second attachment portion in an optical axis direction of the lens apparatus is changeable.

### BACKGROUND

### Field of the Technology

The aspect of the disclosure relates to one or more embodiments of an adapter apparatus, a lens system, an auxiliary apparatus, and an imaging system.

### Description of the Related Art

Conventionally, imaging systems are known in which an illumination apparatus (auxiliary apparatus) is attachable to a lens apparatus mounted on an image pickup apparatus. In attaching the illumination apparatus to the lens apparatus, in order to support multiple types of lens apparatuses, a predetermined adapter apparatus is attached to a lens-filter screw portion disposed at the front end of the lens apparatus, and the illumination apparatus is attached via the adapter apparatus. In some cases, a dedicated illumination apparatus is attached to a lens apparatus having a dedicated attachment portion.

Japanese Patent Application Publication No. 2007-171505 discloses a lens hood that acquires distance information based on reflected light using an illumination apparatus. Japanese Patent Application Publication No. 2003-091039 discloses an illumination apparatus attachable to a lens apparatus having a dedicated attachment portion.

However, when an adapter apparatus attached to the lens-filter screw portion is used for a lens apparatus in which a front lens protrudes forward, a load may be applied to the optical-system driving unit of the lens apparatus, possibly resulting in degradation of optical performance.

Since the configurations disclosed in Japanese Patent Applications Publication Nos. 2007-171505 and 2003-091039 require the lens apparatus to have a dedicated attachment portion corresponding to the illumination apparatus, it becomes difficult to support various types of lens apparatuses having different aperture diameters or angles of view.

### SUMMARY

One or more embodiments of an adapter apparatus for attaching an auxiliary apparatus to a lens apparatus according to one or more aspects of the disclosure may include a first attachment portion attachable to the lens apparatus, and a second attachment portion to which the auxiliary apparatus is attachable. A distance between the first attachment portion and the second attachment portion in an optical axis direction of the lens apparatus is changeable. A lens system and an imaging system each having the above adapter apparatus may constitute another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating the external appearance of an imaging system according to a first embodiment.

FIGS. 2A and 2B are perspective views illustrating the external appearance of the imaging system according to the first embodiment, with a flash (or strobe) apparatus and an adapter apparatus removed.

FIGS. 3A, 3B, 3C, and 3D are perspective views illustrating the external appearance of the adapter apparatus according to the first embodiment.

FIGS. 4A and 4B are a top view and a front view, respectively, of the imaging system according to the first embodiment.

FIGS. 5A, 5B, 5C, and 5D are cross-sectional views illustrating the attachment and detachment of the adapter apparatus to and from a lens apparatus according to the first embodiment.

FIGS. 6A and 6B are cross-sectional views illustrating the attachment of the flash apparatus to the adapter apparatus according to the first embodiment.

FIG. 7 is a cross-sectional view illustrating a relationship between the adapter apparatus and the lens apparatus in the imaging system according to the first embodiment.

FIGS. 8A, 8B, 8C, and 8D are perspective views illustrating the external appearance of an adapter apparatus according to a second embodiment.

FIGS. 9A, 9B, and 9C are cross-sectional views of the adapter apparatus according to the second embodiment.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

### FIRST EMBODIMENT

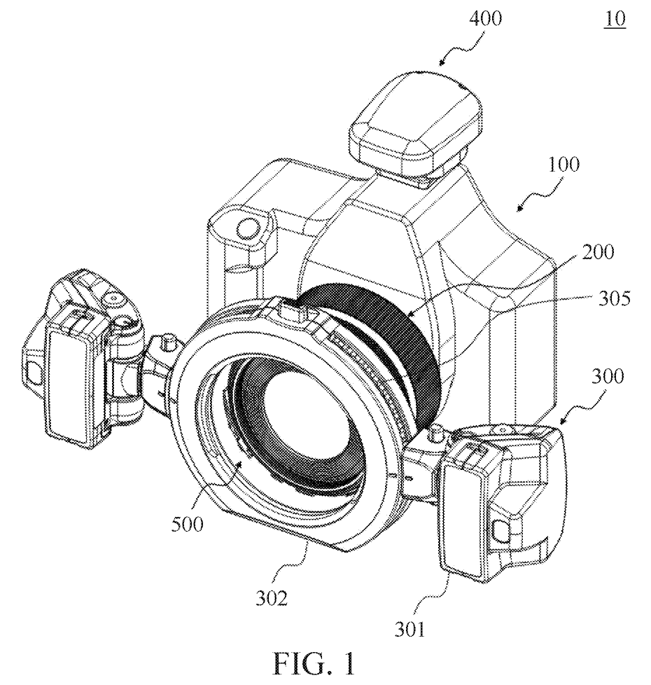

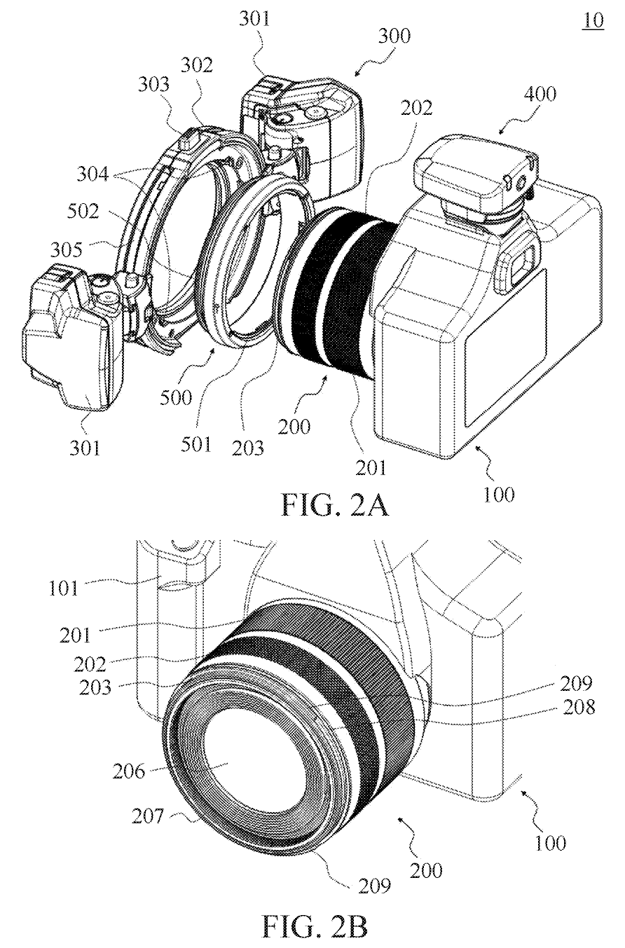

Referring first to FIGS. 1, 2A, and 2B, a description will be given of an imaging system (lens system) 10 according to a first embodiment of the disclosure. FIG. 1 is a perspective view illustrating the external appearance of the imaging system 10. The imaging system 10 includes a camera body (image pickup apparatus) 100, a lens apparatus 200, a flash apparatus (auxiliary illumination apparatus for imaging) 300, a transmitter 400, and an adapter apparatus 500. FIG. 2A is a perspective view illustrating the state in which the flash apparatus 300 and the adapter apparatus 500 are removed from the lens apparatus 200. FIG. 2B is a perspective view illustrating a lens-accessory fixing portion 203 located at the front end of the lens apparatus 200 in the state illustrated in FIG. 2A.

As illustrated in FIG. 1, the lens apparatus 200 is mounted on the front surface of the camera body 100 and is configured such that an image is formed on an image sensor (not illustrated) through the optical system in the lens apparatus 200. The lens apparatus 200 is attachable to and detachable from (interchangeable with) the camera body 100, and they are electrically connected via a group of mount contacts (not illustrated). The camera body 100 includes, on its upper surface, an accessory shoe (not illustrated) to which the transmitter 400 can be attached, thereby allowing both mechanical and electrical connection between the camera body 100 and the transmitter 400.

The flash apparatus 300 is mechanically connected to the front end of the lens apparatus 200 via the adapter apparatus 500. The adapter apparatus 500 is optimized for the lens apparatus 200 as described later and is typically provided as a dedicated adapter corresponding to each type of lens apparatus. The flash apparatus 300 is a twin-light type illumination apparatus including two compact light emitters 301 and a main ring 302. Each light emitter 301 can be detached from the main ring 302 and can change the irradiation direction. Inside each light emitter 301, a xenon tube, a battery, and a wireless module (not illustrated) are provided. The light emitter 301 receives a light emission instruction signal from the camera body 100 via the transmitter 400 and emits light in synchronization with imaging. Each light emitter 301 can be rotated along a guide portion 305 of the main ring 302 and fixed at a position desired by the user.

Although in this embodiment the lens apparatus 200 is an interchangeable lens, the disclosure is not limited to this example; the lens apparatus may be integrated with the camera body 100. While a twin-light-type flash apparatus 300 is used as the auxiliary illumination apparatus in this embodiment, the illumination apparatus is not limited to this example; other types, such as organic EL lights or LED lights, may also be used. The communication between the camera body 100 and the flash apparatus 300 is performed wirelessly via the transmitter 400, but a configuration in which a wireless module is built into the camera body 100 may also be adopted. Alternatively, the transmitter 400 may be integrated into the control unit of the flash apparatus 300 and connected thereto by wire, in which case the light emitters 301 may include only the xenon emission function.

As illustrated in FIG. 2A, the lens apparatus 200 includes a focus ring 201 and a control ring (operation member) 202 to which a variety of functions can be assigned. At the front end of the lens apparatus 200, the lens-accessory fixing portion 203 is provided for attaching a lens hood to the lens apparatus 200. The adapter apparatus 500 includes a lens attachment portion (first attachment portion) 501 having a shape equivalent or compatible with that of the lens hood. By fixing the lens attachment portion 501 to the lens-accessory fixing portion 203 in common with or in place of the lens hood, the adapter apparatus 500 can be attached to the lens apparatus 200.

As illustrated in FIG. 2B, the lens-accessory fixing portion 203 includes an accessory contact surface 208 and a pair of upper and lower protrusion portions 209, forming a groove shape between the accessory contact surface 208 and the protrusion portions 209. In attaching the adapter apparatus 500, the adapter apparatus 500 is inserted into the lens apparatus 200 until it contacts the accessory contact surface 208 and is then rotated. Thereby, a flange portion 507 of the lens attachment portion 501 of the adapter apparatus 500 enters and is attached to the groove formed between the accessory contact surface 208 and the protrusion portions 209. Details will be described later.

The adapter apparatus 500 further includes an illumination-apparatus attachment portion (second attachment portion or auxiliary-apparatus attachment portion) 502. Engagement portions 304 provided on the main ring 302 of the flash apparatus 300 are engaged with the illumination-apparatus attachment portion 502, allowing the flash apparatus 300 to be attached to the lens apparatus 200 via the adapter apparatus 500. Four engagement portions 304 are provided at equal intervals along the inner circumference of the main ring 302 and are biased to project toward the inner circumference side. By operating an unlock button 303, the four engagement portions 304 simultaneously retract via a mechanism (not illustrated), allowing attachment and detachment to and from the adapter apparatus 500.

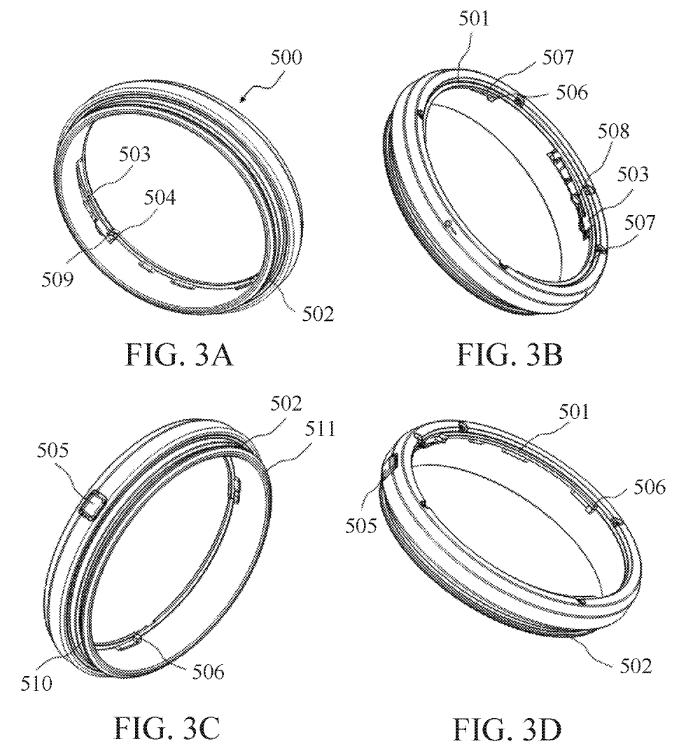

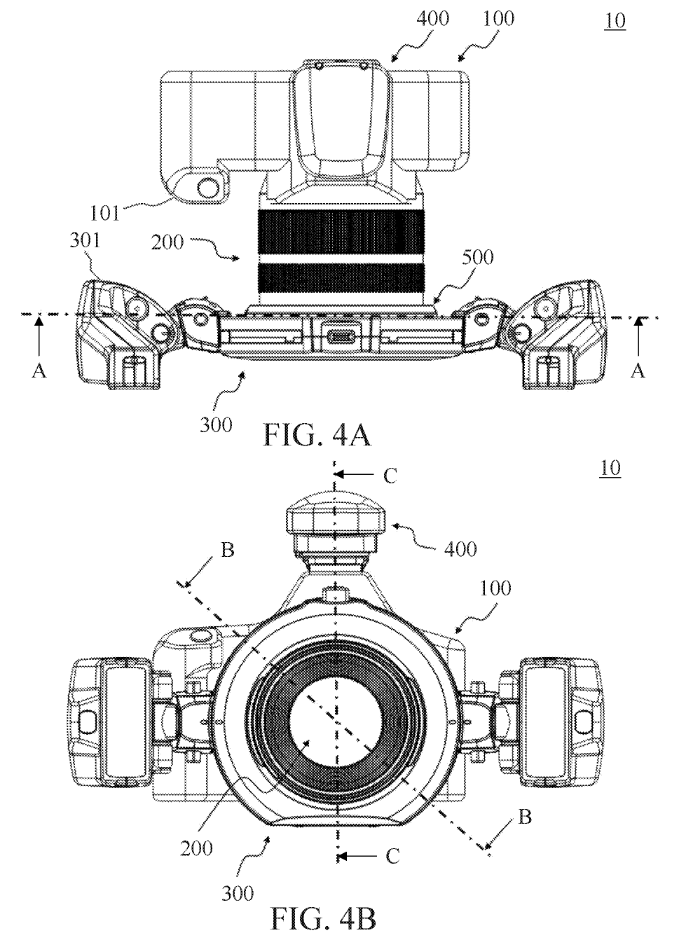

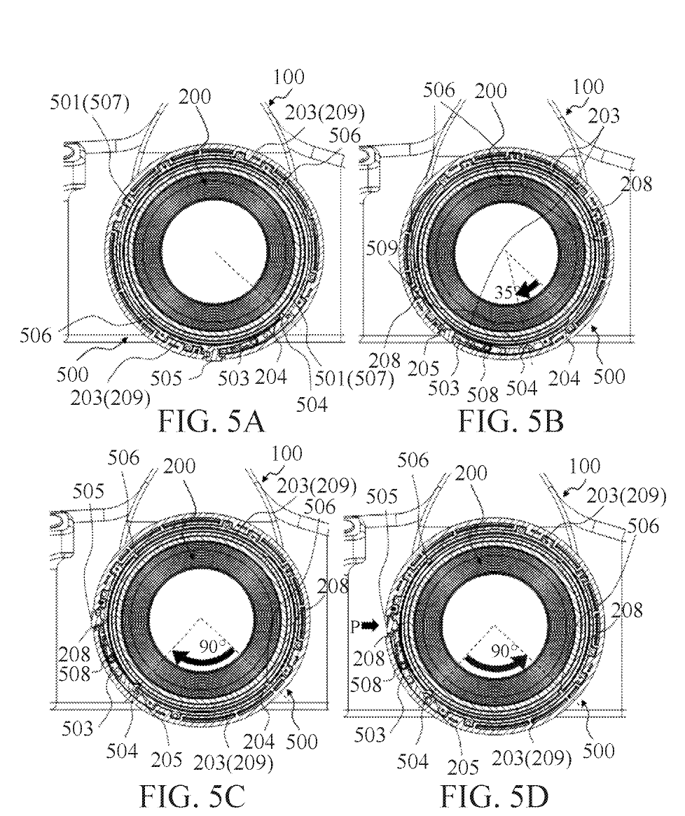

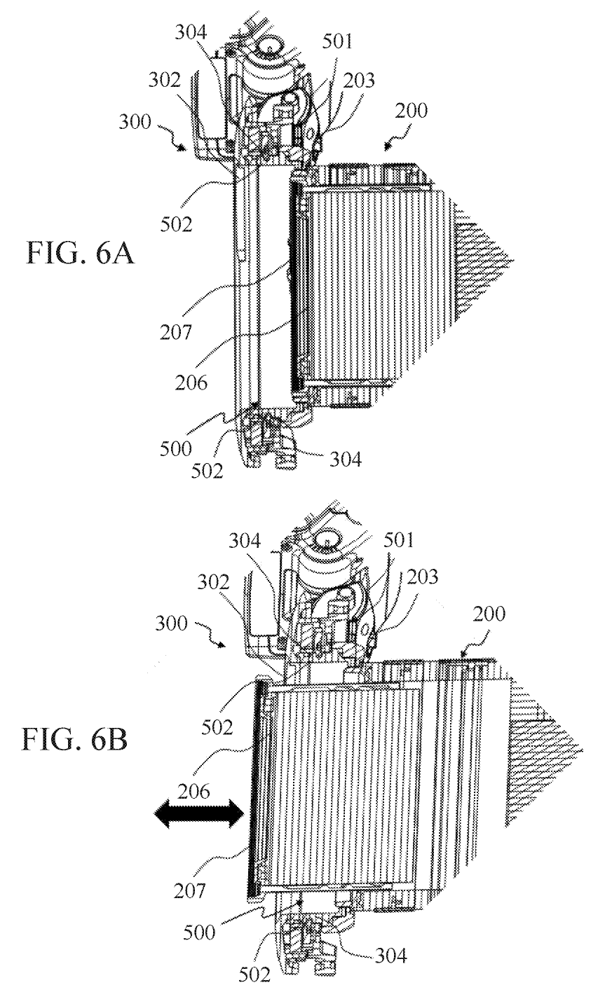

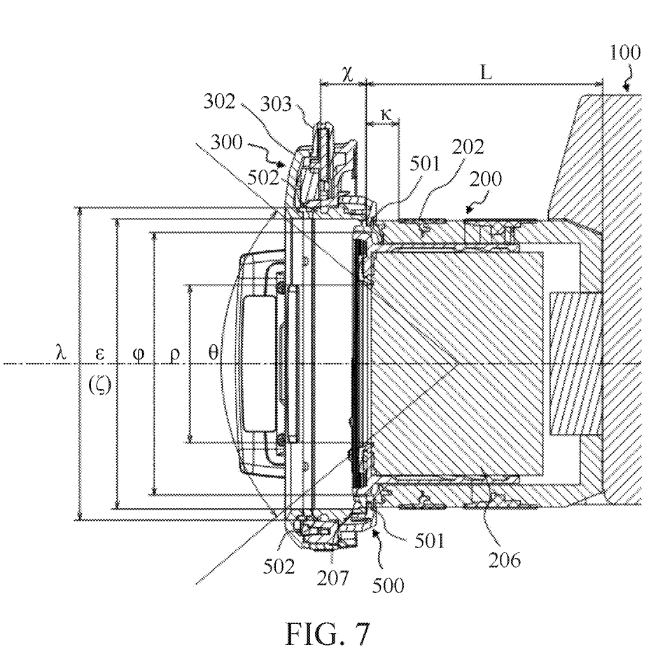

Next, the structures of the adapter apparatus 500 and the imaging system 10 will be described with reference to FIGS. 3A to 7. FIGS. 3A to 3D are perspective views illustrating the external appearance of the adapter apparatus 500 from a variety of angles. FIGS. 4A and 4B are a top view and a front view, respectively, of the imaging system 10 while the adapter apparatus 500 according to this embodiment is attached. FIGS. 5A to 5D are cross-sectional views taken along a line A-A in FIG. 4A, illustrating the attachment and detachment of the adapter apparatus 500 to and from the lens apparatus 200. FIGS. 6A and 6B are cross-sectional views taken along a line B-B in FIG. 4B, illustrating the attachment of the flash apparatus 300 to the adapter apparatus 500. FIG. 7 is a cross-sectional view taken along a line C-C in FIG. 4B, illustrating a relationship between the adapter apparatus 500 and the lens apparatus 200 in the imaging system 10 according to this embodiment.

As illustrated in FIGS. 3A, 3B, 3C, and 3D, the adapter apparatus 500 according to this embodiment includes the lens attachment portion 501 and the illumination-apparatus attachment portion 502. The lens attachment portion 501 projects toward the inner circumference side of the adapter apparatus 500 and includes a flange portion 507, a stopper 506, and a lock lever 503. The flange portion 507 is engaged with the lens-accessory fixing portion 203 of the lens apparatus 200 in the optical axis direction. The stopper 506 restricts a rotation amount when the adapter apparatus 500 is attached to the lens apparatus 200. The lock lever 503 prevents rotation of the adapter apparatus 500 after the adapter apparatus 500 is attached to the lens apparatus 200 (attachment completion). The lock lever 503 includes a lock portion 504 and a button portion 505 and is swingable about a shaft portion 508. A coil spring biases the lock portion toward the inner circumference side. By pressing the button portion 505 exposed on the outer surface of the adapter apparatus 500, the lock lever 503 rotates, retracting the lock portion 504 toward the outer circumference side. A tilted cam surface 509 is formed on the inner side (toward the shaft portion 508) of the lock portion 504. On the other hand, the illumination-apparatus attachment portion 502 includes an attachment ring 510 having a circumferential groove. An end surface of the attachment ring 510 constitutes an illumination-apparatus contact surface 511, against which the main ring 302 of the flash apparatus 300 abuts in the optical axis direction of the lens apparatus 200.

Referring now to FIGS. 5A, 5B, 5C, and 5D, a description will be given of the attachment and detachment of the adapter apparatus 500 to and from the lens apparatus 200. First, the lens attachment portion 501 of the adapter apparatus 500 is inserted from the front end side of the lens apparatus 200 until it contacts the accessory contact surface 208 of the lens-accessory fixing portion 203. As illustrated in FIG. 5A, the stopper 506, lock portion 504 of the lock lever 503, and flange portion 507 of the lens attachment portion 501 are positioned in a phase region where no protrusion portions 209 of the lens-accessory fixing portion 203 are provided.

FIG. 5B illustrates a state before attachment is completed where the adapter apparatus 500 has been rotated by 35° clockwise. At the beginning of the rotation, the lock portion 504 of the lock lever 503 contacts the protrusion portion 209 of the lens-accessory fixing portion 203, but due to the action of the cam surface 509, it rides over the protrusion portion 209 and retracts, allowing rotation. As the adapter apparatus 500 rotates, the flange portion 507 slides into the space between the protrusion portion 209 and the accessory contact surface 208 of the lens-accessory fixing portion 203.

FIG. 5C illustrates a state after the adapter apparatus 500 has been rotated by 90° from the state in FIG. 5A to complete the attachment. The stopper 506 of the adapter apparatus 500 contacts an end portion 204 of the protrusion portion 209 of the lens-accessory fixing portion 203, restricting rightward rotation. Simultaneously, the lock portion 504 of the lock lever 503, having passed over the protrusion portion 209, drops toward the inner circumference side due to a biasing force, thereby preventing leftward rotation of the adapter apparatus 500. In this state, the flange portion 507 slides in the paper-plane depth direction and prevents detachment of the adapter apparatus 500 in the optical axis direction from the lens apparatus 200, while the actions of the stopper 506 and lock portion 504 restrict movement in the rotational direction. Thereby, the adapter apparatus 500 is fixed to the lens apparatus 200. In order to detach the adapter apparatus 500, as illustrated in FIG. 5D, the button portion 505 formed on the lock lever 503 is pressed to retract the lock portion 504 and release engagement with the protrusion portion 209. Therefore, it may be rotated leftward to return it to the state in FIG. 5A.

Next, with reference to FIGS. 6A and 6B, a method of attaching the flash apparatus 300 to the adapter apparatus 500 will be described. FIG. 6A is a cross- sectional view illustrating a state in which the flash apparatus 300 is attached to the adapter apparatus 500 attached to the lens apparatus 200. First, in a state in which the unlock button 303 is pressed to retract the engagement portions 304, the main ring 302 of the flash apparatus 300 is brought into contact with the illumination-apparatus contact surface 511 of the adapter apparatus 500 from the left side. When the pressing of the unlock button 303 is released, the engagement portions 304 having the biasing forces are engaged with the groove of the attachment ring 510 of the adapter apparatus 500, thereby completing attachment.

Unlike the attachment method between the adapter apparatus 500 and the lens apparatus 200 using the rotational operation, the flash apparatus 300 is attached to the adapter apparatus 500 through an action (operation) in the optical axis direction. Therefore, even if the lock lever 503 of the lens attachment portion 501 is not fully engaged, the adapter apparatus 500 will not detach from the lens apparatus 200 during the attachment of the flash apparatus 300. Furthermore, since the illumination-apparatus attachment portion 502 has an annular structure, the flash apparatus 300 can be attached (fixed) at an arbitrary position in the rotational direction about the optical axis of the lens apparatus 200 in view of the illumination effect in imaging. Thereby, in combination with the guide portion 305, the light emitters 301 can be arranged around the optical axis of the lens apparatus 200 without substantial restriction in the rotation direction.

This embodiment may attach the flash apparatus 300 to the adapter apparatus 500 before the adapter apparatus 500 is attached to the lens apparatus 200, and integrally attach the flash apparatus 300 and the adapter apparatus 500 to the lens apparatus 200. FIG. 6B illustrates a state in which a front-lens driving unit 206 of the lens apparatus 200 is driven forward while the flash apparatus 300 is attached to the adapter apparatus 500 as illustrated in FIG. 6A. The adapter apparatus 500 is attached to the lens-accessory fixing portion 203 provided on the outer circumference of the front-lens driving unit 206 of the lens apparatus 200, and is provided with an illumination-apparatus attachment portion 502 that extends forward with a larger inner diameter. Therefore, even when the front-lens driving unit 206 extends or retracts, its movement is not obstructed. In the lens apparatus 200, a lens-filter screw portion 207 is provided at the front end of the front-lens driving unit 206; therefore, attachment of a lens filter is not affected. In other words, the lens attachment portion 501 can be attached to the lens apparatus 200 even in a state where a lens filter is attached to the lens apparatus 200.

As described above, the adapter apparatus 500 is basically a dedicated apparatus corresponding to the lens apparatus 200 to which it is to be attached. This is because it is set according to the difference in size (diameter) of the lens-accessory fixing portion 203 based on the aperture diameter of the lens apparatus 200, the overall length of the lens apparatus 200, and optical characteristics such as the imaging angle of view of the lens apparatus 200.

Next, a relationship between the adapter apparatus 500 and the lens apparatus 200 will be described with reference to FIG. 7. FIG. 7 is a cross-sectional view illustrating the relationship between the adapter apparatus 500 and the lens apparatus 200.

In FIG. 7, θ denotes an angle of view of the lens apparatus 200, ρ denotes a front lens diameter (outer diameter of the front lens), and φ denotes an outer diameter of the front-lens driving unit 206. ε denotes an inner diameter (aperture diameter) of the adapter apparatus 500 through which the front-lens driving unit 206 passes. ζ denotes an inner diameter (aperture diameter) of the main ring 302 of the flash apparatus 300. χ denotes a distance in the optical axis direction between the lens attachment portion 501 and the illumination-apparatus attachment portion 502 of the adapter apparatus 500. L denotes a distance from the lens-accessory fixing portion 203 of the lens apparatus 200 to a lens mount portion (not illustrated) where the lens apparatus 200 is attachable to the camera body 100. κ denotes a distance from the front end of the lens apparatus 200 to the operation unit closest to the adapter apparatus 500 (in this embodiment, from the front end of the lens apparatus 200 to the control ring 202). λ denotes an attachment ring diameter of the illumination-apparatus attachment portion 502.

As described above, at least the inner diameter ε of the adapter apparatus 500 is set larger than the outer diameter φ of the front-lens driving unit 206. As illustrated in FIG. 7, the inner diameter ζ of the main ring 302 is set to be approximately equal to the inner diameter ε of the adapter apparatus 500. However, the adapter apparatus 500 is attachable to various types of illumination apparatus. The size of the illumination-apparatus attachment portion 502, i.e., the attachment ring diameter λ, is set to a predetermined value, but depending on the illumination apparatus used, the overall size may increase, and thus there is an upper limit to the attachment ring diameter λ. Furthermore, depending on the illumination apparatus to be attached, there may be an apparatus such as a so-called ring light that has a light emitter on the front side of the main ring 302, causing the main ring 302 to protrude further forward.

In a case where the adapter apparatus 500 or the flash apparatus 300 is disposed within a range of effective light rays (light rays that contribute to imaging) determined by the angle of view θ and the front lens diameter ρ of the lens apparatus 200, part of the incident light may be blocked, and a captured image can be shielded. In order to prevent interference with the incident light within the limited attachment ring diameter λ of the illumination-apparatus attachment portion 502, the adapter apparatus 500 is designed as follows according to the lens apparatus to be applied.

That is, the distance (relative position) in the optical axis direction between the lens attachment portion 501 and the illumination-apparatus attachment portion 502 of the adapter apparatus 500 may be adjusted so that the flash apparatus 300 and the adapter apparatus 500 are disposed outside the range of the effective light ray. If the distance χ is reduced (including cases where the relative position is reversed), the lens apparatus 200 is positioned further forward relative to the flash apparatus 300. Therefore, the light shielding caused by the flash apparatus 300 and the adapter apparatus 500 can be prevented.

Conversely, depending on the lens apparatus 200, the distance χ may be increased. For example, in a case where the distance L of the lens apparatus 200 is short, as illustrated in FIG. 4A, and the devices are close to each other, such as a grip portion 101 and the light emitter 301 illustrated in FIG. 4A, the light emitter 301 may hit the user's hand, degrading operability. Therefore, in the lens apparatus 200 with a short distance L, the device usability can be improved by setting the distance χ to a longer value as necessary.

An operation unit disposed close to the flash apparatus 300, such as the control ring 202 provided on the lens apparatus 200, may cause the user's hand to hit the flash apparatus 300, degrading operability. Therefore, even when the distance κ is short, the device usability can be improved by increasing the distance χ as needed. Since reducing and increasing the distance χ are mutually exclusive, for example, if there is a lens apparatus with a wide effective light ray range and a short distance L, the attachment ring diameter λ may be increased. Therefore, the attachment ring diameter λ may be determined based on all the conditions of the lens apparatus 200 and illumination apparatus in which the adapter apparatus 500 is expected to be used.

As described above, enabling the adapter apparatus 500 to be attached to the lens-accessory fixing portion 203 of the lens apparatus 200 can reduce the load applied to the driving of the lens apparatus 200. Furthermore, by adjusting the distance χ between the lens attachment portion 501 and the illumination-apparatus attachment portion 502 according to the lens apparatus 200 to which the adapter apparatus 500 is applied, an imaging system with an illumination apparatus can be provided without degrading optical characteristics or operability. In this embodiment, at least one of the lens attachment portion 501 and the illumination-apparatus attachment portion 502 may be configured interchangeably so as to change the distance χ.

In this embodiment, the auxiliary apparatus is the flash apparatus 300, which is a type of illumination apparatus. However, this embodiment is not limited to illumination apparatuses. This embodiment is also applicable to other types of auxiliary apparatuses, such as a so-called gelatin filter holder or other similar members that are disposed on the front surface of the lens apparatus 200 and serve to hold a thin-film filter or the like for changing the optical characteristics of incident light.

### SECOND EMBODIMENT

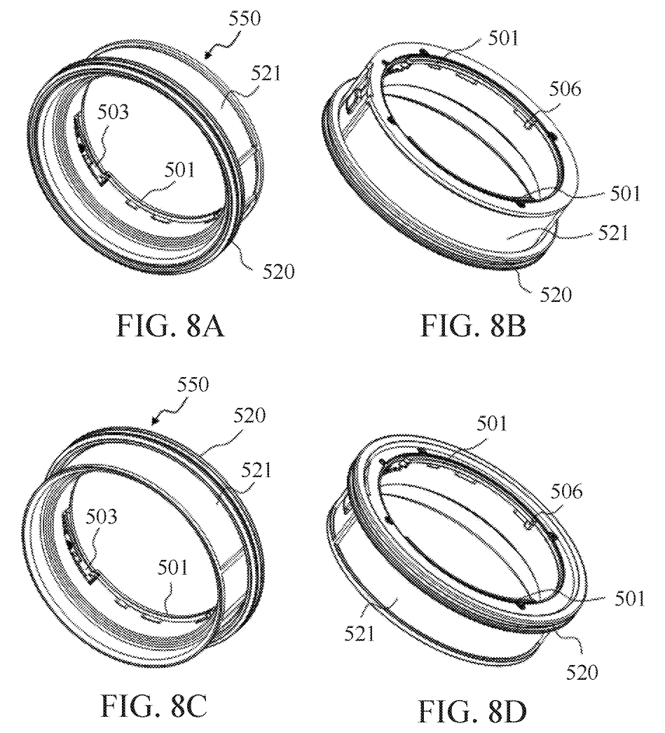

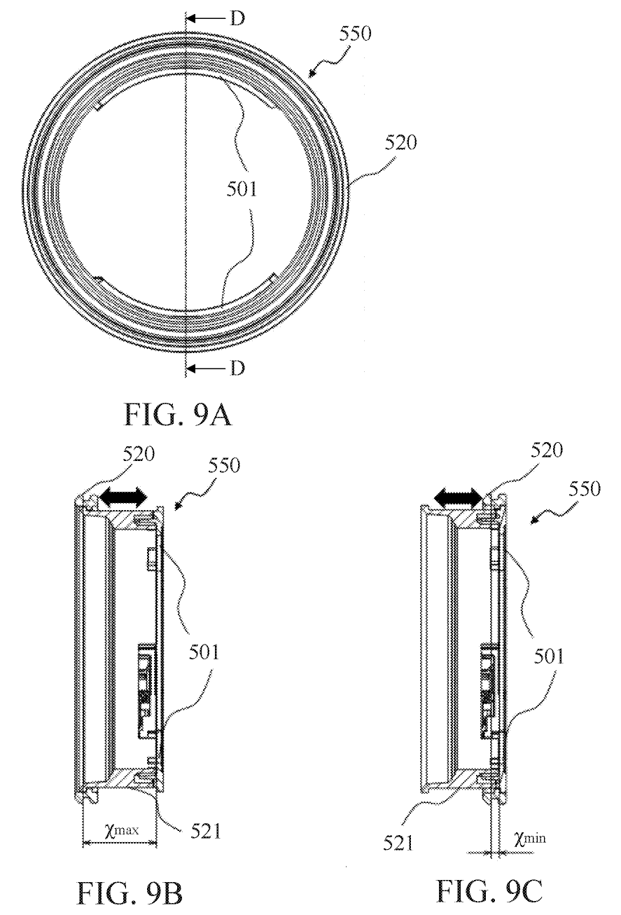

Referring now to FIGS. 8A to 9C, a description will be given of an adapter apparatus 550 according to a second embodiment of the disclosure. The adapter apparatus 550 according to this embodiment differs from the adapter apparatus 500 having the illumination-apparatus attachment portion 502 with the fixed distance χ, in that the adapter apparatus 550 includes a movable illumination-apparatus attachment portion (second attachment portion) 520 configured to allow the distance χ to be variable. In this embodiment, those elements, which are corresponding elements in the adapter apparatus 500 according to the first embodiment, will be designated by the same reference numerals, and a detailed description thereof will be omitted.

FIGS. 8A and 8B are perspective views illustrating the adapter apparatus 550 in a state where the distance χ is at its maximum. FIGS. 8C and 8D are perspective views illustrating the adapter apparatus 550 in a state where the distance χ is at its minimum. FIG. 9A is a cross-sectional view of the adapter apparatus 550 viewed along the optical axis direction. FIG. 9B is a cross-sectional view taken along a line D-D in FIG. 9A, illustrating a state where the distance χ is at its maximum. FIG. 9C is a cross-sectional view taken along a line D-D in FIG. 9A, illustrating a state where the distance χ is at its minimum.

As illustrated in FIGS. 8A to 9C, the adapter apparatus 550 according to this embodiment mainly includes four structural elements: the lens attachment portion 501, the lock lever 503, the movable illumination-apparatus attachment portion 520, and the sliding barrel portion 521. The movable illumination-apparatus attachment portion 520 is slidable on the sliding barrel portion 521 in the left-right direction (i.e., in the arrow direction, the optical axis direction), as illustrated in FIGS. 9B and 9C. This configuration enables the adapter apparatus 550 to vary the distance χ in accordance with the optical characteristics of the lens apparatus 200 to which it is attached. That is, the lens attachment portion 501 of the adapter apparatus 550 can be commonly used for multiple types of lens apparatuses 200 having a common shape of lens-accessory fixing portion 203. Furthermore, a single adapter apparatus 550 can be used with a zoom lens or other types of lens apparatuses in which the angle of view θ is variable.

As described above, the movable illumination-apparatus attachment portion 520 can change the distance χ. Thereby, an adapter apparatus can be provided which can flexibly accommodate the optical characteristics of a variety of lens apparatuses. In this embodiment, the movable illumination-apparatus attachment portion 520 is movable along the optical axis direction to change the distance χ, but this embodiment is not limited to this example. For example, the lens attachment portion 501 may be movable in the optical axis direction to change the distance χ. That is, in this embodiment, at least one of the lens attachment portion 501 and the movable illumination-apparatus attachment portion 520 may be movable in the optical axis direction for changing the distance χ.

Each embodiment can provide an adapter apparatus, a lens system, and an imaging system, each of which can be attached to multiple types of lens apparatuses and that are less likely to affect an optical-system driving mechanism of the lens apparatus when an auxiliary apparatus is attached.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions. For example, an auxiliary apparatus having the adapter apparatus according to each embodiment also constitutes another aspect of the disclosure.

This application claims the benefit of Japanese Patent Application No. 2025-004485, filed on January 14, 2025, which is hereby incorporated by reference herein in its entirety.

What is claimed is:

1. An adapter apparatus for attaching an auxiliary apparatus to a lens apparatus, the adapter apparatus comprising:
a first attachment portion attachable to the lens apparatus; and
a second attachment portion to which the auxiliary apparatus is attachable,
wherein a distance between the first attachment portion and the second attachment portion in an optical axis direction of the lens apparatus is changeable.

2. The adapter apparatus according to claim 1, wherein the distance between the first attachment portion and the second attachment portion in the optical axis direction of the lens apparatus is changeable such that the first attachment portion and the second attachment portion are disposed outside a range of effective light rays of the lens apparatus.

3. The adapter apparatus according to claim 1, wherein at least one of the first attachment portion and the second attachment portion is interchangeable to change the distance.

4. The adapter apparatus according to claim 1, wherein at least one of the first attachment portion and the second attachment portion is movable in the optical axis direction to change the distance.

5. The adapter apparatus according to claim 1, wherein a distance between the first attachment portion and the second attachment portion in an optical axis direction of the lens apparatus is changeable according to an angle of view of the lens apparatus, a front lens diameter of the lens apparatus, and an aperture diameter of the auxiliary apparatus.

6. The adapter apparatus according to claim 1, wherein the first attachment portion is attachable to a fixing portion of the lens apparatus, and
wherein a distance between the first attachment portion and the second attachment portion in an optical axis direction of the lens apparatus is changeable according to a distance from the fixing portion to a lens mount portion of the lens apparatus, and a distance from the fixing portion to an operation portion of the lens apparatus that is closest to the adapter apparatus.

7. The adapter apparatus according to claim 1, wherein the second attachment portion is configured to enable the auxiliary apparatus to be attached at an arbitrary position in a rotational direction around an optical axis of the lens apparatus.

8. The adapter apparatus according to claim 1, wherein the first attachment portion is attachable to a fixing portion of the lens apparatus that is used for attaching a lens hood.

9. The adapter apparatus according to claim 1, further comprising a lock portion configured to prevent rotation of the adapter apparatus after the adapter apparatus is attached to the lens apparatus.

10. The adapter apparatus according to claim 1, wherein an aperture diameter of the adapter apparatus is larger than an outer diameter of a driving unit of the lens apparatus.

11. The adapter apparatus according to claim 1, wherein the first attachment portion is attachable to the lens apparatus by being rotated around an optical axis of the lens apparatus, and
wherein the auxiliary apparatus is attachable to the second attachment portion by being operated in an optical axis direction of the lens apparatus.

12. The adapter apparatus according to claim 1, wherein the first attachment portion is attachable to the lens apparatus while a lens filter is attached to the lens apparatus.

13. The adapter apparatus according to claim 1, wherein the auxiliary apparatus is an illumination apparatus.

14. A lens system comprising:
an adapter apparatus according to claim 1; and
the lens apparatus.

15. An auxiliary apparatus comprising:
the adapter apparatus according to claim 1.

16. An imaging system comprising:
the adapter apparatus according to claim 1;
the lens apparatus; and
an image pickup apparatus.
